(19) United States
(12) Patent Application Publication
(10) Pub. No.: US 2005/0257099 A1
(43) Pub. Date: Nov. 17, 2005

(54) Information embedding method

(76) Inventors: Stephane Bounkong, Paris (FR); David Lowe, Malvern Wells Worcs (GB); David Saad, Selly Park Birmingham (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/514,619

(22) PCT Filed: May 19, 2003
(86) PCT No.: PCT/GB03/02142

§ 371 Date: May 19, 2005

(30) Foreign Application Priority Data
May 18, 2002 (GB) 0211488.2

(51) Int. Cl. G06F 11/00

(52) U.S. Cl. 714/48

(57) ABSTRACT

A method of embedding a message vector (m) in a data set. The method is domain independent and comprises the steps of (I) performing a transformation (W) on a first data set (x) to produce a second data set (S), the second data set (S) consisting of a plurality of statistically mutually independent components (independent sources), (ii) selecting from the second data set (S) a subset of data components (V) which constitutes an embedding space (feature space) in which the message vector (V) is to be embedded, (iii) modifying the data subset (V) in a predetermined manner according to the message vector (m) to be embedded, whereby to embed the message vector (m) in the second data set (S), and (iv) performing a reverse transformation (A) on the second data set having the message vector embedded therein (Ŝ) to reproduce the first data set now having the message embedded therein (x, watermarked text).

The present invention, in one aspect, relates to a method of embedding a message vector in a dataset (covertext). In particular the present invention is concerned with robust and fragile watermarking.

Steganography, the art of information hiding, has entered a new phase in the last decade, with the growing use of digital media, the internet and the on-line trade in electronic information (I. Cox et. al., Digital Watermarking: Principles & Practice, Morgan Kaufmann (2001)). Steganography covers a broad range of objectives from copyright protection, watermarking and fingerprinting to authentication and the embedding of subtitle information in video images. Although these applications share some common characteristics, they can be quite different in their objectives. Thus, watermarking is still a combination of science and art. Most of the methods employ established techniques, imported from a particular application domain, for devising watermarking schemes especially tailored and particularly suitable for that domain. This is reflected in the methods suggested for the watermark embedding process and the feature space chosen for this purpose.

In fragile watermarking, it is intended that any attack on the covertext results in destruction of the watermark (i.e. loss of information). In robust watermarking, the opposite is true, i.e. attack on the covertext should leave the watermark intact.

The plethora of watermarking methods on offer and the narrow suitability to specific domains make it difficult to provide a principled comprehensive theoretical approach to watermarking. Such an approach is a prerequisite to any optimisation scheme aimed at maximising the information embedding rate and the robustness against various attacks, and minimising the information degradation.

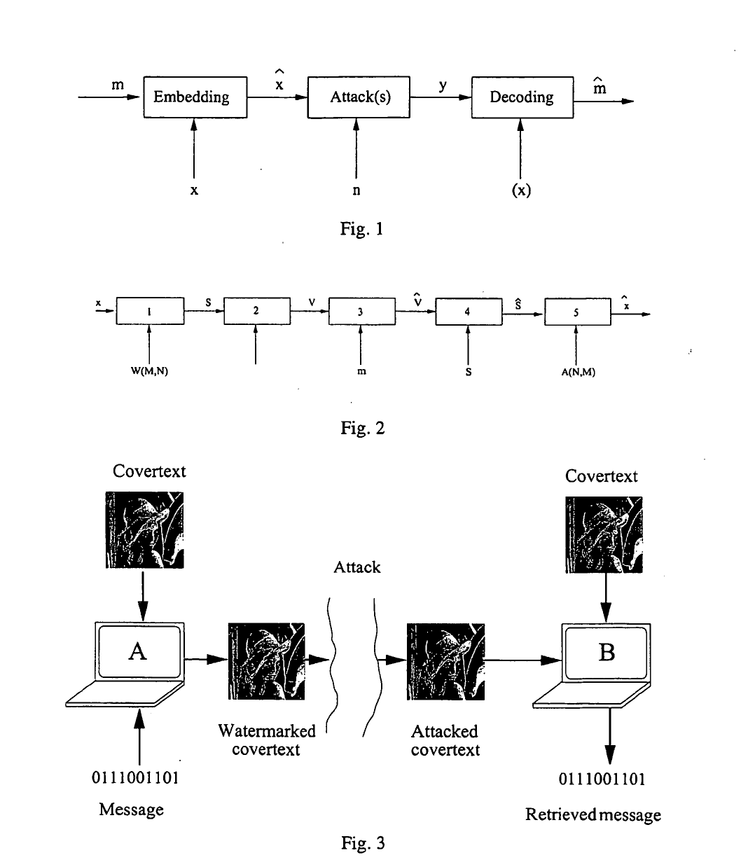

The general framework of a watermarking system is shown in FIG. 1. The message vector m (such as text or serial number), is hidden (embedded) in the covertext vector x (for instance digitised image), producing the watermarked covertext \hat{x}. The watermarked covertext \hat{x} can be attacked, either maliciously or non-maliciously, resulting in the modified vector y; the attack itself is represented by the vector n. Decoding (message extraction) is carried out with or without the original covertext (termed private and blind watermarking respectively) to provide an estimate of the original message (watermark) \hat{m}.

According to a first aspect of the present invention there is provided a method of embedding a message vector in a data set comprising the steps of:
(i) performing a transformation on a first data set to produce a second data set, the second data set consisting of a plurality of statistically mutually independent components,
(ii) selecting from the second data set a subset of data components which constitutes an embedding space in which the message vector is to be embedded,
(iii) modifying said data subset in a predetermined manner according to the message vector to be embedded, whereby to embed the message vector in the second data set, and
(iii) performing a reverse transformation on the second data set having the message vector embedded therein to reproduce the first data set now having the message embedded therein.

In the field of steganography, the dataset in which the message is embedded is usually referred to as a “covertext” and the covertext in which the message is embedded is referred to as the “marked” or “watermarked” covertext. The independent data components making up the embedding space (or feature space) may be abbreviated to “independent components”, or are sometimes referred to as “independent sources”. References to such phrases should be construed accordingly.

The nature of the covertext is not limited, but is preferably a digital image, audio data or video data.

The present invention relates to a new approach to watermarking which is substantially independent of the application domain. It is equally applicable to fragile and robust watermarking. It is based on embedding the message in a set of independent sources, derived from the covertext, through the use of constant mixing matrices. Different generative models may be used for identifying the set of independent sources. These sources, or a subset of them, constitute the spanning of a feature space, also termed embedding space. The mixing matrices may differ from one application domain to another, but the probability distributions of the sources themselves are almost uncorrelated with the application domain. The transformation of the covertext (first data set) into the statistically independent sources is often referred to as de-mixing, the reverse transformation being referred to as mixing.

The present invention is particularly suited to robust watermarking (i.e. the embedded message is intended to remain after an attack) although it can also be used in fragile watermarking.

Preferably, the independent sources selected in step (i) are identified by independent component analysis (A. Hyvärinen et. al., Independent Component Analysis, John Wiley & Sons, NY (2001)), independent factor analysis (H. Attias, Neural Computation, 11, 803, 1998), a kernel based method (eg. radial basis functions), a neural network or generative topographic mapping. Although said methods have not previously been proposed in the steganography field for robust watermarking, they are per se known in other unrelated technical fields. It will be readily apparent to the skilled person that once the independent sources have been identified, the transformation of step (i) is readily derivable.

The use of ICA assumes that the covertexts constitute a sufficiently uniform class so that a statistical model can be constructed on the basis of observations. It will be appreciated that a different model may need to be constructed for significantly different covertext groups.

This new approach is aimed at achieving close to capacity information transmission rate for the embedded message by using close to Gaussian source distributions. The method based on a zero mean i.i.d (independent and identically distributed) Gaussian covertext has been shown to have the largest watermarking capacity of all ergodic covertexts, and their most malevolent additive attack is also known analytically. Thus, the generative model used to identify the independent sources should ideally include Gaussian-like sources to be used as the feature space for embedding the message (watermark). If, for instance, the source distribution is produced by ICA, which cannot include pure Gaussian source distributions (P. O. Hoyer et. al., Network, 11, 191, 2000), the message is embedded in source distributions which have the highest resemblance to a Gaussian.

The embedding in step (iii) may be linear or non-linear. Suitable embedding techniques include Quantisation Index Modulation (QIM), with or without Distortion-Compensation (DC-QIM) (B. Chen et. al., IEEE Trans. Inform. Theory, 47, 1423, 2001) and scaled bin encoding (A. Levy et. al., HPL-2001-13, HP laboratories Israel, technical report 2001). These (and others) are well known to the person skilled in steganography.

Preferably, the method includes the additional step, prior to step (iii), of encoding the message vector. More preferably, said encoding is achieved using Low Density Parity Check error correcting codes (T. Richardson et. al., IEEE Trans. on Inform. Theory, 47, 619, 2001 and D. J. C. MacKay, IEEE Trans. on Inform. Theory, 45, 399, 1999). Such encoding increases robustness against attacks.

The first aspect of the present invention also resides in a carrier medium carrying a computer executable software program for controlling a computer to carry out the method of the first aspect of the present invention.

Preferably, the carrier medium is a storage medium, such as a floppy disk, CD-ROM, DVD or a computer hard drive. Although it will be understood that the carrier medium may also be a transient carrier eg. an electrical or optical signal.

According to a second aspect of the present invention, there is provided a method of extracting a message vector embedded in a dataset in accordance with the first aspect of the invention, from a dataset which has been modified (attacked).

Preferably, said method comprises the steps of:
(i) applying the transformation to the modified dataset to produce a modified second dataset of statistically independent components, and
(ii) comparing each data component which constitutes the embedding space with the corresponding data component in the modified second data set, whereby to determine the message information content for each component of the modified dataset.

In cases where it is not known which specific data components of the data set have been used to embed the message vector, the method includes an additional step prior to step (ii) of identifying which data components constitute the embedding space.

Said method may be achieved by thresholding the independent components obtained from the modified dataset. For example, deviation of the modified data component from the corresponding data component of the original embedding space by more than a predetermined amount is registered as a message bit (eg. above an upper threshold value corresponding to a “1” bit, and below a lower threshold corresponding to a “0” bit).

Alternatively, said method may be achieved using a principled probabilistic approach. For example, an approximation to the embedded message vector can be obtained by the probabilistic modelling of the dataset modification (attack) process.

It will be understood that the method of the second aspect also relates to the extraction of the embedded message vector from an unmodified covertext.

The second aspect of the present invention also resides in a carrier medium carrying a computer executable software program for controlling a computer to carry out the method of the second aspect of the present invention.

Preferably, the carrier medium is a storage medium, such as a floppy disk, CD-ROM, DVD or a computer hard drive. Although it will be understood that the carrier medium may also be a transient carrier eg. an electrical or optical signal.

Embodiments of the present invention will now be described by way of example only, with reference to the accompanying drawings, in which:

FIG. 1 is a schematic representation of a typical watermarking process,

FIG. 2 is a schematic representation of a watermarking process of the present invention,

FIG. 3 is a schematic representation of a preferred embodiment, in which a serial number is embedded in a digital image, and

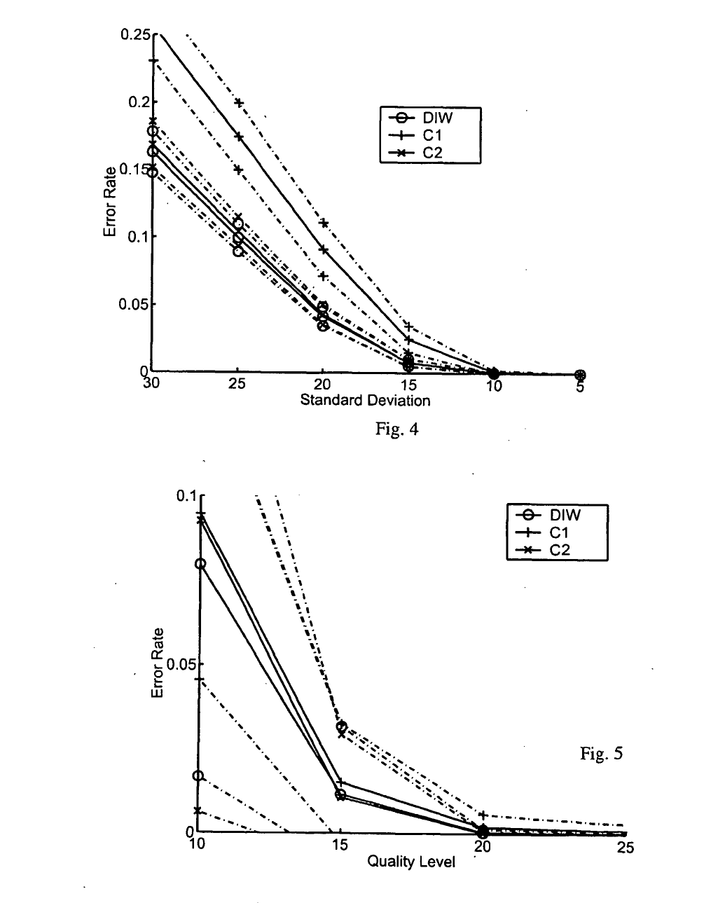

FIGS. 4 to 6 illustrate graphically the performance of a watermarking method in accordance with the present invention relative to known watermarking methods for various attacks.

FIG. 2 shows a watermarking scheme based on independent sources identified by a generative model, in this instance using the ICA/IFA feature space. The variables x represents the N dimensional original covertext, transformed (box 1) to the M dimensional feature space S using the ICA demixing matrix W (M×N). The vector of selected coefficients V representing a selected subset of independent sources (box 2), constitutes the space used for embedding the message m. Embedding of the message m (box 3) results in a modification of the vector V and the feature space S (denoted by \hat{V} and Ŝ respectively). The latter is optimised (box 4) to minimise the perceptible distortion; mixing the feature space coefficients Ŝ (box 5), using the mixing matrix A(N×M), results in a modified (i.e. watermarked) version of the original covertext \hat{x}.

Considering each aspect of the process in more detail:

1. Identification and Transformation into Independent Components

The first aspect of the embedding process is choosing an appropriate space for the embedding process. Ideally, the method should be domain independent with minimal cross-interference between the embedded signal and other signal components. The space chosen in the present invention is that of statistically independent sources. The main reasoning is that if the various components (sources) are statistically independent then modifying one of them will have a minimal impact on the others, thus reducing the cross-interference between the embedded signal and the covertext. In addition, the independent components are almost uncorrelated with the application domain, as most of the information about the application domain is obtained from the constant mixing matrix W, such that the original covertext S is obtained by S=Ax where x is the vector of statistically independent components, and A is the transpose of matrix W.

The statistically independent components in the present embodiment are selected for the whole covertext. However, the components can be selected for a section of the covertext, as this may be more practical in some cases. For instance, it is more practical to consider patches of a digitised picture than the complete picture; this speeds up considerably the computation of the mixing matrices and the independent sources. Similarly, it may be more efficient and/or suitable to identify independent sources in a transformed version of the original covertext (e.g., a Fourier or wavelet transformation of the original covertext).

2. Selection of Sources for Embedding Space

The selection of sources may depend on some pre-determined measure; for example sources may be selected that maximise the information capacity and minimise the covertext distortion. For instance, the information capacity measure may be defined as the Shannon entropy ratio between the message and covertext (T. Cover et. al., Elements of Information Theory, John Wiley & Sons, NY (1991)); and the distortion measure may rely on a quadratic Euclidean distance between the original and watermarked covertext vectors and/or their mutual information (T. Cover et. al., supra). In fragile watermarking, maximising the information capacity is less important, and the sources will be chosen accordingly.

Alternatively, the choice of sources can be randomised, thereby making it difficult for an attacker to identify and remove the watermark. In a modification, the predetermined selection and randomised selection approaches can be combined: an initial selection of sources is made based on an information measure (lowest ranked information carrying sources are rejected since these may well be inadvertently lost in, for example, legitimate compression).

3. Embedding Method

Various efficient linear and non-linear approaches have been suggested for hiding/embedding information and any of these may be used in the present invention. In the present case, QIM is used. This method is based on quantising the covertext real-valued independent source to some central value, followed by a quantised addition/subtraction representing the binary message bit. This is then modified by a prescribed noise template making it difficult to identify the QIM embedding process and its parameters. In other embodiments, this latter step may be omitted. The space comprising the (modified) independent sources is then mixed to generate the watermarked covertext.

4. Encoding (Not Shown)

To make the embedded information more robust against attacks, the message is encoded prior to embedding, by using the Low Density Parity Check (LDPC) error Correcting Codes.

5. Message Extraction (Decoding)

The decoding problem can be viewed as a general inference task and may be carried out in various ways. For instance, it may be carried out by employing the de-mixing matrix to the attacked covertext to give the corrupt sources and thresholding these sources (i.e. setting thresholds around the selected source values for identifying the quantised message) or by principled probabilistic techniques. An optimal message estimation can be based on Bayesian methods employing a probabilistic model of the corruption process P(y|\hat{x}); the latter may be approximated using standard modelling techniques (C. M. Bishop, Neural Networks for Pattern Recognition, Oxford University Press, Oxford, 1995) (eg. mixture of Gaussians). In this method, the message is estimated on the basis of the posterior P(m|y) (maximum a posteriori—MAP) or the marginal posterior P(mᵢ|y), ∀ᵢ (marginal posterior maximiser—MPM), with or without explicit knowledge of the original covertext and its properties.

FIG. 3 shows a preferred embodiment of the invention based on embedding a message, for instance, a binary string representing a serial number, in a digitised picture. The embedding processing is carried out using computer A, which then delivers the data (covertext), either via communication lines or using a memory device (e.g., an optical or magnetic disc), to a customer. The covertext may be subjected to attacks. Information from the attacked version is extracted by computer B. It is also possible for computer B to extract information from the attacked version without knowledge of the original covertext or embedding method.

The new watermarking system is robust against various standard attacks. These attacks can be conveniently categorised under five main sub-headings (illustrated in the context of digital images):
A) Synchronisation attacks—geometric transformations such as rotation and flip;
B) Frame attacks—line/column omissions; resampling, scaling and mosaic (breaking the pictures into patches);
C) Content attacks—by noising, blurring, sharpening, de-noising and signal processing;
D) Content Information reduction—lossy compression, colour reduction and down-scaling; and
E) Collusion attacks—exploiting common information in watermarked signals.

To validate the method, experiments were carried out to compare the performance of the proposed approach (“domain independent watermarking “DIW”) to known watermarking methods. The covertext used in these experiments was arbitrarily chosen to be digitised images. Watermarking parameters were optimised in all methods, and separately for each specific attack.

For comparison purposes, two other watermarking schemes have been tested under the same attacks and using the same embedding and decoding methods. Both methods operate in the discrete cosine transform (DCT) domain:
C1 This scheme is based on the DCT of the whole image, X, selecting a random coefficient set for the message m to be embedded in using QIM.
C2 In the second scheme, the image is divided into contiguous patches. The DCT of each patch is used as covertext X. A set of coefficients is selected and then quantised for embedding m.

In both schemes, an inverse DCT is applied after message embedding to provide the watermarked image. It should be noted that local methods such as C2 and DIW (as applied in this case) are much more computationally efficient than global methods such as C1.

The experiments involved attacking the watermarked pictures by:
a) white noise (WN) of mean zero and of various standard deviation values;
b) JPEG lossy compression with different quality levels; and
c) resizing with various factors.

These attacks are, arguably, the most common attacks (e.g. the most common type of noise and compression standard) and are therefore frequently used as a benchmark in this field. The set of images used comprised eleven grey-scale pictures representing natural, as opposed to computer generated, scenes. The experiments are carried out ten times for each set of parameters for each picture, providing both mean performance and error bars on the measurements.

Each algorithm embeds, using a quantisation method characterized by a quantisation step δ, a message m of length 1024 bits with a maximum distortion of 38 dB. The distortion induced by the watermarking systems was measured by the peak signal to noise ratio (PSNR). A simple decoding scheme based on nearest decoding was also used for all systems. The Table below summarises the parameters used in the experiments. In each of FIGS. 4 to 6, solid lines represent mean values for the experiments, dashed lines either side represent the error bars.

TABLE
Parameters for watermarking methods according to attack applied

| Attack | | | Noise | | JPEG | | Resizing | |
|---|---|---|---|---|---|---|---|---|
| Scheme | Transform | Patch Size | Coef. Rg. | δ | Coef. Rg. | | Coef. Rg. | δ |
| DIW | ICA | 16 by 16 | 38-50 | 155 | 6-10 | 36 | 6-10 | 36 |
| C1 | DCT | — | 101-1124 | 70 | 2081-20624 | 70 | 2-1985 | 70 |
| C2 | DCT | 16 by 16 | 6-23 | 80 | 2-19 | 80 | 4-18 | 80 |

FIG. 4 shows that all schemes are reasonably robust considering that the 38 dB attack distortion threshold is reached for a standard deviation of about 3. It also shows that DIW is the most robust method of those examined for a WN attack. In the case of DIW and the decoding method used, it is easy to see a direct relation between δ and the robustness of the process, since the noise in the feature space is also Gaussian. This may not be the case if other decoding methods, such as the Bayesian approach are used. Moreover it also shows that one potential weakness of the DIW scheme, the ICA restriction of extracting only non-Gaussian sources, is not highly significant, even in the case of a Gaussian noise attack.

FIG. 5 shows that all the tested methods are reasonably robust against JPEG compression. However, for very low quality levels (under 15), performances decrease significantly, and are less stable as shown by the error bars (error correcting codes (ECC) may be employed in low error rates for improving the performance). Furthermore the threshold of 38 dB distortion is reached at a quality level of about 90. DIW achieved the best results on average.

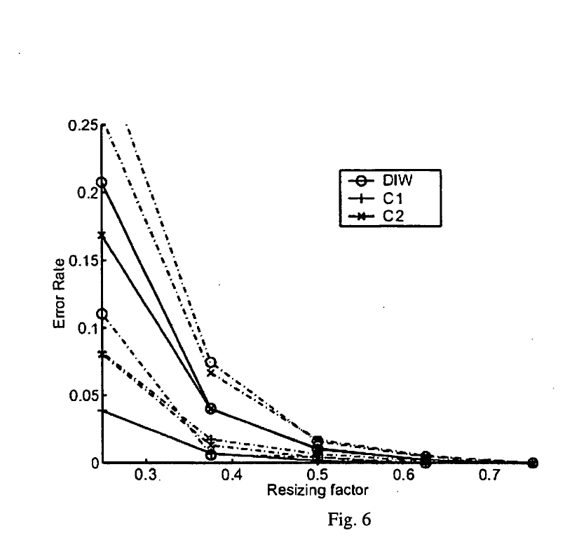

FIG. 6 shows excellent performances for C1 under resizing attacks. DIW and C2 achieved excellent results for a resizing factor greater than 0.5, but their performances decreased significantly for stronger attacks. Intuitively this can be explained by the localised nature of the patches used. It is expected that ECC will allow perfect retrieval for a resizing factor down to 0.375; lower factors will severely affect capacity of these schemes and the picture quality. For a 0.25 resizing factor, the picture size is reduced by more than 98% in storage.

The method of the present invention exhibits several advantages in comparison with existing techniques. Firstly, being domain independent, it may be adapted easily to different watermarking tasks. Secondly, the source selection mechanism enables close to optimal covertext (in feature space) to be chosen and reduces the distortion in the original covertext. Thirdly, encoding the message prior to the embedding operation, using state of the art error-correcting codes, increases its robustness against attacks. Finally, using principled probabilistic decoding techniques, based on modelling the attack, enables maximisation of the information extracted from the attacked covertext.

From the foregoing, it will be appreciated that the present invention is a highly efficient and highly robust domain independent watermarking system. The message embedding can be carried out easily and efficiently, such that the hidden message can be extracted fully and reliably from the attacked covertext. Any attack which successfully removes the watermark is likely to distort the covertext to an excessive extent; thereby depriving the attacker of any further use of the covertext (eg. degraded audio files or digital images).

1. A method of embedding a message vector in a data set comprising:
(i) performing a transformation on a first data set to produce a second data set, the second data set consisting of a plurality of statistically mutually independent components,
(ii) selecting from the second data set a subset of data components which constitutes an embedding space in which the message vector is to be embedded,
(iii) modifying said data subset in a predetermined manner according to the message vector to be embedded, whereby to embed the message vector in the second data set, and
(iv) performing a reverse transformation on the second data set having the message vector embedded therein to reproduce the first data set now having the message embedded therein.

2. The method of claim 1, wherein the first dataset is selected from a digital image, audio data or video data.

3. The method of claim 1, wherein the independent components of step (i) are identified by independent component analysis, independent factor analysis, a kernel based method such as radial basis functions, a neural network or generative topographic mapping.

4. The method of claim 1, wherein the subset of independent components selected in step (ii) are selected randomly or in accordance with a predetermined measure or a combination thereof.

5. The method of claim 4, wherein the predetermined measure is a combination of an information measure and a distortion measure, said measures selected to maximise the information capacity of the subset of independent components while minimising the distortion on the first data set due to embedding of the message vector.

6. The method of claim 1, wherein the embedding method of step (iii) is selected from Quantisation Index Modulation, with or without Distortion-Compensation and scaled bin encoding.

7. The method of claim 1, further comprising an additional step, prior to step (iii), of encoding the message vector.

8. The method of claim 7, wherein said encoding is achieved using error correcting codes.

9. A method of extracting a message vector embedded in a data_set, said data_set possibly having been modified, the method of embedding said message vector in said data set comprising:
(i) performing a transformation on a first data set to produce a second data set, the second data set consisting of a plurality of statistically mutually independent components,
(ii) selecting from the second data set a subset of data components which constitutes an embedding space in which the message vector is to be embedded,
(iii) modifying said data subset in a predetermined manner according to the message vector to be embedded, whereby to embed the message vector in the second data set, and
(iv) performing a reverse transformation on the second data set having the message vector embedded therein to reproduce the first data set now having the message embedded therein.

10. The method of claim 9, comprising the steps of:
(i) applying the transformation to the nominally modified data_set to produce a nominally modified second data set of statistically independent components, and
(ii) comparing each data component which constitutes the embedding space with the corresponding data component in the nominally modified second data set, whereby to determine the message information content for each component of the nominally modified data_set.

11. The method of claim 10, comprising the additional step prior to step (ii) of identifying which data components constitute the embedding space.

12. The method of claim 11, comprising the step of thresholding the independent components obtained from the nominally modified dataset to identify which data components constitute the embedding space.

13. The method of claim 12, wherein the message information content is determined by said thresholding.

14. The method as claimed in claim 10 wherein determination of the message information content is achieved using a principled probabilistic approach.

15. The method of claim 14, wherein the dataset is known to have been modified and an approximation to the embedded message vector is obtained by the probabilistic modelling of the dataset modification process.

16. A carrier medium carrying a computer executable software program for controlling a computer to carry out a method of embedding a message vector in a data set comprising:
(i) performing a transformation on a first data set to produce a second data set, the second data set consisting of a plurality of statistically mutually independent components,
(ii) selecting from the second data set a subset of data components which constitutes an embedding space in which the message vector is to be embedded,
(iii) modifying said data subset in a predetermined manner according to the message vector to be embedded, whereby to embed the message vector in the second data set, and
(iv) performing a reverse transformation on the second data set having the message vector embedded therein to reproduce the first data set now having the message embedded therein.

17. The carrier medium of claim 16, wherein said medium is at least one storage medium selected from the group consisting of: a floppy disk, CD-ROM, DVD, a computer hard drive, and a transient carrier.
